(19) United States
(12) Patent Application Publication
(10) Pub. No.: US 2014/0096542 A1
(43) Pub. Date: Apr. 10, 2014

(54) System Using Refrigeration System Waste Heat

(71) Applicants: Stephen M. Wadle, Beloit, WI (US); Robert K. Newton, Beloit, WI (US); Kenneth C. Moshier, Roscoe, IL (US)

(72) Inventors: Stephen M. Wadle, Beloit, WI (US); Robert K. Newton, Beloit, WI (US); Kenneth C. Moshier, Roscoe, IL (US)

(73) Assignee: Carrier Corporation, Farmington, CT (US)

(21) Appl. No.: 14/122,696

(22) PCT Filed: May 15, 2012
(86) PCT No.: PCT/US2012/037910

§ 371 Date: Nov. 27, 2013

Related U.S. Application Data
(60) Provisional application No. 61/492,516, filed on Jun. 2, 2011.

(51) Int. Cl. A23L 1/025

(52) U.S. Cl. CPC A23L 1/025
USPC 62/62; 62/238.6

(57) ABSTRACT

A system using waste heat of a refrigeration unit to heat a food product, having a heating loop connected to a refrigeration unit between the compressor and the condenser, and configured to allow refrigerant to enter the heating loop to transfer heat to a food product.

### CROSS-REFERENCE TO RELATED APPLICATION

Reference is made to and this application claims priority from and the benefit of U.S. Provisional Application Ser. No. 61/492,516, filed Jun. 2, 2011, and entitled SYSTEM USING REFRIGERATION SYSTEM WASTE HEAT, which application is incorporated herein in its entirety by reference.

### BACKGROUND OF THE INVENTION

This invention relates generally to a refrigeration system used in a frozen dessert system and, more particularly, the use of waste heat from a refrigeration system to heat syrups and other dessert toppings.

A refrigeration system is employed to cool a mix in a frozen dessert system, such as a milkshake or ice cream dispenser. The frozen dessert system typically includes a hopper which stores the mix and a freezing cylinder that cools and mixes air into the mix prior to serving. The freezing cylinder is cooled by a refrigeration system. The hopper may also be cooled by the refrigeration system depending on the frozen dessert to be dispensed. Refrigerant is compressed in a compressor to a high pressure and high enthalpy. The refrigerant then flows through a condenser where the refrigerant rejects heat and is cooled. The high pressure low enthalpy refrigerant is then expanded to a low pressure. After expansion, the refrigerant flows through the tubing encircling the freezing cylinder and/or hopper, accepting heat from and cooling the freezing cylinder, and therefore the mix. After cooling the freezing cylinder and/or hopper, the refrigerant is at a low pressure and high enthalpy and returns to the compressor for compression, completing the cycle.

An option on a typical frozen dessert system is heated syrup or other heated topping. Syrup is placed in a reservoir with a hand activated syrup pump for dispensing the syrup. The syrup reservoir is typically placed into an outer reservoir. Water is placed into the outer reservoir to act as a double boiler arrangement. In some arrangements to heat the syrup, an electrical resistance heater is placed onto the outer surface of the outer reservoir. A control thermostat and a high limit thermostat are configured in series with this heater to control and limit the temperature of the water and syrup. During steady state conditions in room ambient temperature, the heater requires the use of energy to heat the syrup.

Another method used to heat the syrup is the addition of a heat exchanger feedback loop to receive refrigerant flow from the compressor discharge to the compressor suction. In this arrangement, refrigerant exits the compressor, passes through a control valve to the heat exchanger loop, and loops back into the intake of the compressor. In this system, additional energy is used to heat the syrup because the refrigerant is returned directly to the compressor suction after heating the syrup and not used for cooling.

### BRIEF SUMMARY OF THE INVENTION

A system using waste heat of a refrigeration unit to heat a food product, having a heating loop connected to a refrigeration unit between the compressor and the condenser, and configured to allow refrigerant to enter the heating loop to transfer heat to a food product.

In an exemplary embodiment, the present system directs refrigerant exiting the compressor into a heating loop, which heats the syrup. The refrigerant is then fed into the condenser. The refrigerant performs cooling work once it reaches the evaporator. The present system provides reduced energy consumption since the syrup will be heated by the waste heat from the compressor of the refrigeration system. Additional energy savings result as well from reduced cooling load on the refrigeration system since the condenser load will decrease by the amount of heating that is done by the heating loop.

According to an exemplary embodiment, a system for using waste heat of a refrigeration unit to heat a food product is provided. The system includes a heating loop configured to be connected to a line of a refrigeration unit connecting a compressor and a condenser; the heating loop connected to the line at an upstream location and at a downstream location; a heating valve connected to the heating loop; a thermostatic control connected to the heating valve and configured to open the heating valve to allow refrigerant to enter the heating loop at the upstream location and exit the heating loop at the downstream location; and a reservoir heat exchanger connected to the heating loop and configured to allow refrigerant to enter the reservoir heat exchanger to transfer heat to a food product reservoir.

In another exemplary embodiment, a food dispenser refrigeration system is provided. The system includes a refrigeration unit having a compressor to compress a refrigerant to a high pressure; a condenser for cooling said refrigerant; a bypass loop for allowing refrigerant to pass between the compressor and the condenser; an expansion device for reducing said refrigerant to a low pressure; and an evaporator for exchanging heat with a freezing cylinder or hopper containing food product; a heating loop connected to the bypass loop at an upstream location and at a downstream location; a heating valve connected to the heating loop; a thermostatic control connected to the heating valve and configured to open the heating valve to allow refrigerant to enter the heating loop; and a reservoir heat exchanger connected to the heating loop and configured to allow refrigerant to enter the reservoir heat exchanger to transfer heat to a food product reservoir.

In yet another exemplary embodiment, a method for heating a food product is provided. The method includes compressing a refrigerant to a high pressure; directing the high pressure refrigerant to a heating loop for transferring heat to a food product reservoir; directing the refrigerant from the heating loop to a condenser for cooling the refrigerant; expanding the refrigerant to a low pressure; directing the low pressure refrigerant to an evaporator to accept heat from and cool a freezing cylinder; and directing the low pressure refrigerant to a compressor for compressing the refrigerant to a high pressure.

### BRIEF DESCRIPTION OF THE DRAWINGS

For a further understanding of the disclosure, reference will be made to the following detailed description which is to be read in connection with the accompanying drawing, wherein:

FIG. 1 schematically illustrates an exemplary embodiment of the system to heat a food product using waste heat from a refrigeration system.

FIG. 2 schematically illustrates another exemplary embodiment of the system to heat a food product using waste heat from a refrigeration system.

FIG. 3 schematically illustrates another exemplary embodiment of the system to heat a food product using waste heat from a refrigeration system.

FIG. 4 schematically illustrates another exemplary embodiment of the system to heat a food product sing waste heat from a refrigeration system.

### DETAILED DESCRIPTION OF THE INVENTION

The exemplary embodiments described herein use waste heat of a refrigeration unit to heat a food product. A heating loop is connected to a refrigeration unit between the compressor and the condenser, and allows refrigerant to enter the heating loop to transfer heat to a food product before being directed toward the condenser of the refrigeration unit. The exemplary embodiments provide reduced energy consumption since waste heat from the compressor of the refrigeration system is used to heat food product and the condenser load will decrease by the amount of heating that is done by the heating loop.

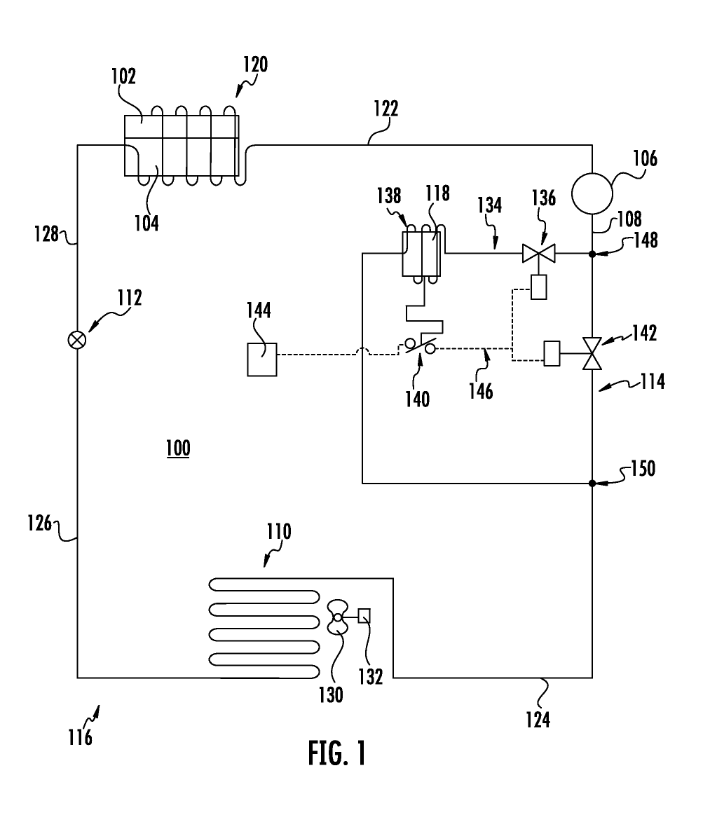

FIG. 1 is a schematic illustration of an exemplary embodiment of a system using waste heat from a refrigeration system 116 to heat a food product.

The frozen dessert dispenser system 100 includes a hopper 102 which stores mix for making a frozen product. In one exemplary embodiment, the hopper 102 may be a twenty quart hopper. The mix flows from the hopper 102 into a freezing cylinder 104 for freezing and mixing with air. In gravity fed systems, a standard air-mix feed tube is used to meter the air into the freezing cylinder 104. In pump systems, air is metered into the freezing cylinder 104 by a pump. The freezing cylinder 104 is a stainless steel freezing cylinder. The frozen product is then dispensed for serving.

Heated food products, such as syrups, fudge or fruit toppings, may be dispensed along with the frozen dessert depending on the request of the customer. For purposes of this discussion, the food product is described as syrup, although other food products may be substituted. The syrup is stored in a syrup reservoir 118 to be heated therein. The syrup reservoir 118 may be placed within an outer reservoir containing water to act as a double boiler arrangement.

The hopper 102 and the freezing cylinder 104 are cooled by a refrigeration system 116. Waste heat of the refrigeration system 116 is used to heat the syrup to be dispensed along with the frozen dessert.

Refrigerant flows through the closed circuit refrigeration system 116. In one exemplary embodiment, the refrigerant is R404A. The refrigerant is compressed in the compressor 106 to a high pressure and high enthalpy. The refrigerant then flows along a line 108 toward a bypass loop 114 and heating loop 134 disposed between the compressor 106 and condenser 110.

The heating loop 134 is a line that directs refrigerant toward a syrup reservoir 118 to heat syrup contained therein. In this manner, the heating loop 134 uses waste heat from the refrigerant system 116 to heat the syrup. The addition of the heating loop 134 provides reduced energy consumption by the food dispenser 100 since the syrup will be heated using the waste heat from the compressor 106 of the refrigeration system 116. Further, the need for an electrical resistance heater to heat the syrup may be eliminated or at least substantially reduced. It is contemplated that in many applications for heating a food product using waste heat from a refrigerant system as disclosed herein, there will be no need for a supplemental electric heater. However, it is to be understood that the energy savings associated with using waste heat from a refrigeration system for heating a food product as disclosed herein will still be realized even when employed in conjunction with supplemental electric heating. Additional indirect energy savings result as well from reduced cooling load since the condenser load will decrease by the amount of heating that is done by the heating loop 134.

In an exemplary embodiment, heating loop 134 is made of copper tubing, although other types of tubing may be used. A heating valve 136 is interdisposed in the heating loop 134. The heating valve 136, which in an exemplary embodiment comprises a solenoid valve and is also referred to herein as solenoid valve 136, controls the flow of refrigerant into the heating loop 134. A reservoir heat exchanger 138, which encircles a syrup reservoir 118, is interdisposed in the heating loop 134. In exemplary embodiment, the reservoir heat exchanger 138 is made of a copper tube refrigeration line wrapped around and soldered to the bottom and the walls of the syrup reservoir 118 having a diameter of approximately 5/16 of an inch in diameter, thereby enwrapping the syrup reservoir 118. However, other diameters and types of tubing can be employed. The surface area of the reservoir heat exchanger 138 soldered to the bottom of the syrup reservoir 118 is preferably maximized.

In some exemplary embodiments, the syrup reservoir 118 is a double boiler-like arrangement, having an inner vessel containing the syrup or condiment, and an outer vessel containing water. In other exemplary embodiments, the syrup reservoir is a single vessel. Additionally, frozen dessert dispensers 100 may have multiple syrup reservoirs 118. In an exemplary embodiment, the reservoir heat exchanger 138 encircles the syrup reservoir(s) 118 to heat the syrup contained therein.

The heating valve 136 controls the flow of refrigerant from the compressor 106 to the heating loop 134. When the syrup reservoir 118 requires heat, the solenoid valve 136 is opened to allow the refrigerant to flow into the heating loop 134 and through reservoir heat exchanger 138, and, therefore, around the syrup reservoir 118. When the syrup reservoir 118 does not require heat, the solenoid valve 136 is closed and prevents entry of refrigerant into the heating loop 134.

Thermostatic control 140 monitors the temperature of the syrup reservoir 118 and/or the syrup contained therein and is electrically connected to the solenoid valve 136 via electrical connection 146. Thermostatic control 140 is also electrically connected to the power supply 144 of the frozen food dispenser 100.

When thermostatic control 140 detects that the temperature of the syrup in the syrup reservoir 118 requires heat, thermostatic control 140 activates the solenoid valve 136 to an open position thereby allowing refrigerant to flow into the heating loop 134 toward downstream position 150 and line 124. When thermostatic control 140 detects that the temperature of the syrup in the syrup reservoir 118 does not require heat, thermostatic control 140 deactivates the solenoid valve 136 to a closed position thereby preventing refrigerant to flow into the heating loop 134.

Since refrigerant has a higher temperature than the water and/or syrup in the syrup reservoir 118, when refrigerant flows into the heating loop 134 and reservoir heat exchanger 138, the heat transfer rate will be positive to the syrup reservoir 118. Thus, the internal thermal energy of the water and/or syrup in the syrup reservoir 118 will increase and the internal thermal energy of the refrigerant will decrease. Increasing the thermal energy of the water and/or syrup will heat the syrup, and decreasing the refrigerant thermal energy will decrease the thermal load on the condenser 110. Since the thermal load of the condenser 110 will be decreased, the high side pressure will decrease and the amount of sub-cooling will increase resulting in a more efficient refrigeration system 116.

In an exemplary embodiment, bypass loop 114 connects to the heating loop 134 at two locations, that is opening in flow communication to the heating loop 134 at an upstream location 148 and at a downstream location 150. As refrigerant flows from compressor 106 to condenser 110, and therefore from line 108 toward line 124, the upstream location 148 is upstream of the downstream location 150 relative to the flow of refrigerant in the refrigeration system. In an exemplary embodiment, the upstream location 148 is located proximate line 108 and the downstream location 150 is located proximate line 124.

Bypass loop 114 is a line used to direct refrigerant from the compressor 106 to the condenser 110 bypassing the heating loop 134. Bypass loop 114 may be made of copper tubing or other materials. In an exemplary embodiment, a solenoid valve 142 may be interdisposed in the bypass loop 114. Solenoid valve 142 controls the flow of refrigerant into the bypass loop 114. Solenoid valve 142 is also electrically connected to thermostatic control 140 via electrical connection 146. In this embodiment, when the thermostatic control 140 detects that the temperature of the syrup in the syrup reservoir 118 requires heat, the thermostatic control 140 deactivates the solenoid valve 142 to a closed position, which prevents refrigerant from entering the bypass loop 114. In this manner, all, or nearly all refrigerant is directed through the heating loop 134.

When thermostatic control 140 detects that the temperature of the syrup in the syrup reservoir 118 does not require heat, as discussed above, thermostatic control 140 deactivates solenoid valve 136 to a closed position, and activates solenoid valve 142 to an open position, thereby preventing or at least substantially restricting refrigerant flow through the bypass loop 134 and allowing all or nearly all refrigerant to flow into the bypass loop 114 toward downstream position 150 and line 124.

Although solenoid valves 136 and 142 have been illustrated and described as controlling the flow of refrigerant into the heating loop 134 and bypass loop 114, other devices can be employed for that purpose.

After refrigerant is directed through either the heating loop 134 or the bypass loop 114, depending on whether the syrup reservoir 118 requires heat, refrigerant then flows along line 124 toward and through the condenser 110. As the refrigerant flows through condenser 110, the refrigerant rejects heat and is cooled as the refrigerant passes in heat exchange relationship with a flow of air established by a fan 130 driven by a motor 132. In an exemplary embodiment, the condenser 110 is a three row 5/16 inch tube and raised lanced fin condenser 110. The condenser 110 can also be a water cooled condenser. However, it is to be understood that other types of condensers 110 can be employed. Additionally, the size of the compressor 106 and the size of the condenser 110 are balanced and related to each other.

The high pressure low enthalpy refrigerant flows away from condenser 110 along line 126. The high pressure low enthalpy refrigerant is then expanded using an expansion device 112. In an exemplary embodiment the expansion device 112 is a capillary tube. In another exemplary embodiment, the expansion device 112 is an expansion valve. In some exemplary embodiments, prior to expansion, the refrigerant flow may be split into two lines. One line may lead to the freezing cylinder 104 and one line may lead to the hopper 102. Each line may have its own associated expansion valve. For example, an AXV expansion valve may be used on a line leading to the freezing cylinder 104. An AXV expansion valve is an automatic expansion valve that constantly regulates pressure to control the evaporating pressure of the refrigerant flowing around the freezing cylinder 104. A TXV expansion valve, or thermal expansion valve, regulates the amount of superheat in the refrigerant at the evaporator outlet and may be used along a line leading to the hopper 102.

After expansion, the refrigerant flows along line 128 through an evaporator 120. Evaporator 120 in one exemplary embodiment is tubing encircling the hopper 102 and freezing tube 104, accepting heat from and cooling the hopper 102 and freezing tube 104, and therefore the mix. In an exemplary embodiment, the evaporator 120 encircling the hopper 102 and freezing tube 104 is a copper tube refrigeration line wrapped around and soldered to the bottom and the walls of the hopper 102 and freezing tube 104 having a diameter of approximately 5/16 of an inch in diameter. However, other diameters of tubing can be employed. The surface area of the evaporator 120 soldered to the bottom of the hopper 102 and freezing tube 104 is preferably maximized.

After cooling the freezing cylinder 104 and the hopper 102, the refrigerant is at a low pressure and high enthalpy and the refrigerant returns to the compressor 106 along line 122 for compression, completing the refrigeration cycle.

As described above, flow of refrigerant into the heating loop 134 is controlled by the use of two solenoid valves 136 and 142.

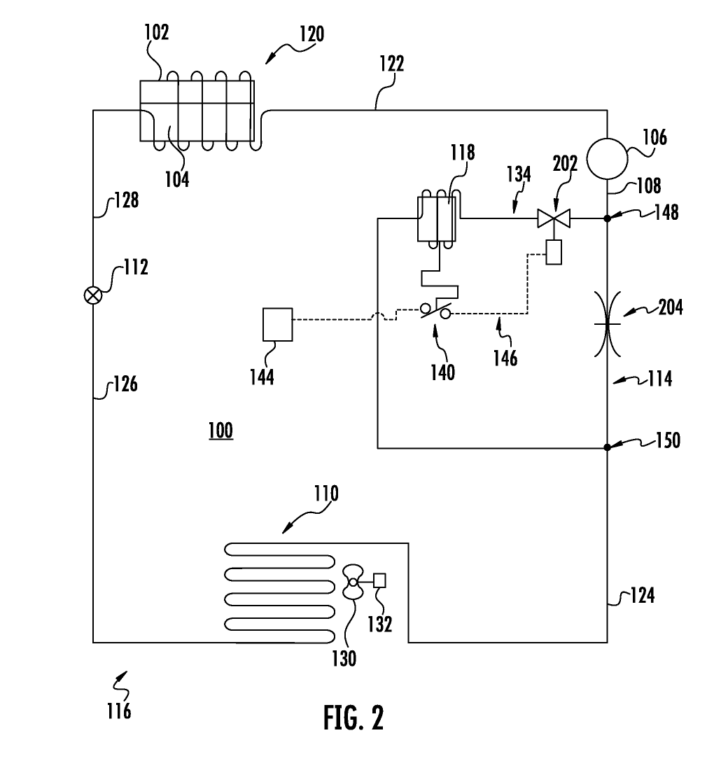

FIG. 2 is a schematic illustration of another exemplary embodiment of a system using waste heat from a refrigeration system 116 to heat a food product using a single solenoid valve 202 positioned along the heating loop 134. In this embodiment, solenoid valve 202 is positioned along heating loop 134 proximate upstream position 148. Solenoid valve 202 is electrically connected to thermostatic control 140 via electrical connection 146. When thermostatic control 140 detects that the temperature of the syrup in the syrup reservoir 118 requires heat, thermostatic control 140 activates the solenoid valve 202 to an open position thereby allowing refrigerant to flow into the heating loop 134 toward downstream position 150 and line 124. When thermostatic control 140 detects that the temperature of the syrup in the syrup reservoir 118 does not require heat, thermostatic control 140 deactivates the solenoid valve 202 to a closed position thereby preventing refrigerant to flow into the heating loop 134.

In this embodiment, when solenoid valve 202 is in a closed state, all or nearly all refrigerant passes through bypass loop 114. When solenoid valve 202 is in an open state, refrigerant simultaneously passes through heating loop 134 and bypass loop 114.

In this embodiment, to achieve adequate flow of refrigerant through the heating loop 134 when solenoid valve 202 is open, a restriction element 204 may be created along bypass loop 114 as depicted in FIG. 2. In other exemplary embodiments, the restriction element is not included.

In an exemplary embodiment, bypass loop 114 is made of copper tubing, although other tubing may be used. The restriction element 204 may be created by narrowing a portion of the bypass loop 114. In one exemplary embodiment, the copper line of the bypass loop 114 is crimped to create the restriction element 204. In this manner, the restriction element 204 creates a pressure drop along the bypass loop 114 that allows refrigerant to flow into the heating loop 134 when the solenoid valve 202 is open. In other exemplary embodiments, the restriction element 204 is a device inserted into the bypass loop 114 to restrict the flow of refrigerant therein.

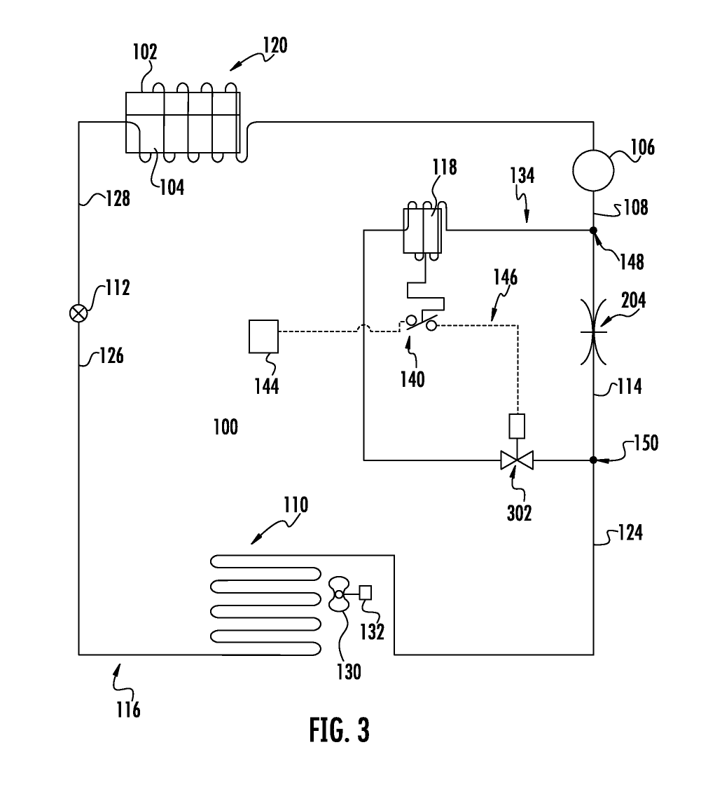

FIG. 3 is a schematic illustration of another exemplary embodiment of a system using waste heat from a refrigeration system 116 to heat a food product using a single solenoid valve 302 positioned along the heating loop 134.

In this exemplary embodiment, solenoid valve 302 is positioned along heating loop 134 proximate downstream position 150. Solenoid valve 302 is electrically connected to thermostatic control 140 via electrical connection 146. When thermostatic control 140 detects that the temperature of the syrup in the syrup reservoir 118 requires heat, thermostatic control 140 activates the solenoid valve 302 to an open position thereby allowing hot refrigerant gas to flow through the heating loop 134 toward downstream position 150 and line 124. When thermostatic control 140 detects that the temperature of the syrup in the syrup reservoir 118 does not require heat, thermostatic control 140 deactivates the solenoid valve 302 to a closed position thereby preventing hot refrigerant gas to flow through the heating loop 134.

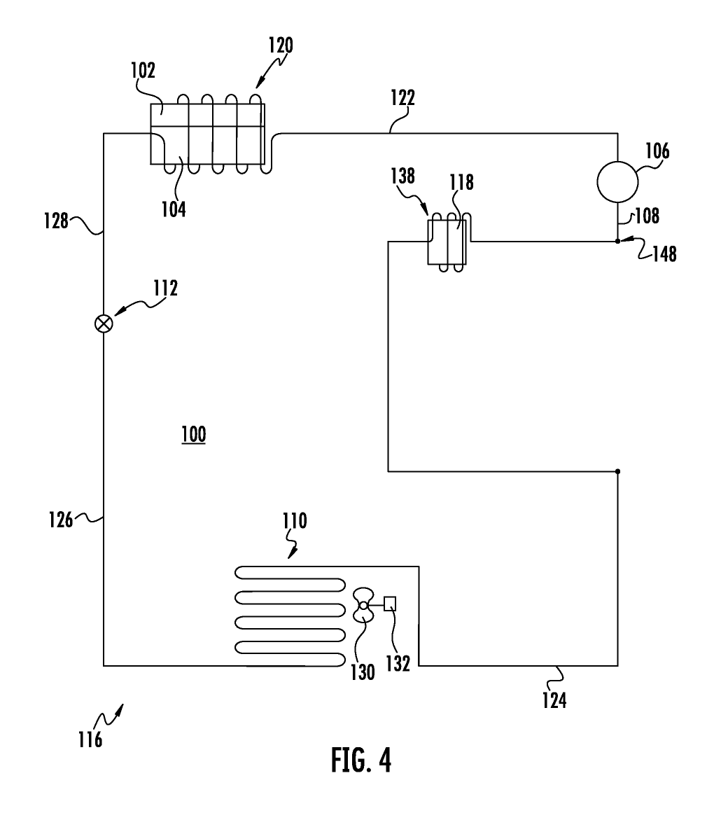

FIG. 4 is a schematic illustration of an exemplary embodiment of a simplified form of a system using waste heat from a refrigeration system 116 to heat a food product. The simplified embodiment depicted in FIG. 4 lacks a bypass loop and the refrigerant flow controls, including the thermostatic control and solenoid valves, associated therewith in the embodiments depicted in FIGS. 1-3. In this simplified embodiment, the reservoir heat exchanger 138 that encircles the syrup reservoir 118 is interdisposed in the refrigerant line extending from the refrigerant discharge outlet of the compressor 106 to the condenser 110. Thus, whenever the compressor 106 of the refrigeration system 116 is operating, that is whenever a demand exists for chilling the hopper 102, all of the refrigerant vapor passing from the compressor 106 passes through the reservoir heat exchanger 138. After traversing the reservoir heat exchanger 138, the refrigerant continues flowing along line 124 to and through the condenser 110, thence along line 126 to and through the expansion device 112 and along line 128 to the evaporator 120. In traversing the evaporator 20, the refrigerant passes in heat exchange relationship with the hopper 102 and the freezing cylinder 104 and the product mix therein whereby the product mix is chilled and the refrigerant evaporated. The refrigerant vapor thence passes from the evaporator 120 through line 122 to return to the compressor 106. Therefore, in the embodiment depicted in FIG. 4, as in the embodiments depicted in FIGS. 1-3, all refrigerant that passes through the reservoir heat exchanger 138 for heating the food product, for example syrup, in the reservoir 118, continues on to pass through the entire refrigerant circuit.

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiments as illustrated in the drawing, it will be recognized by those skilled in the art that various modifications may be made without departing from the spirit and scope of the invention. Therefore, it is intended that the present disclosure not be limited to the particular embodiment(s) disclosed as, but that the disclosure will include all embodiments falling within the scope of the appended claims.

We claim:

1. A system for using waste heat of a refrigeration unit to heat a food product, the refrigeration unit having a line connecting a compressor to a condenser, and a refrigerant flowing through the line, the heating system comprising:
a heating loop configured to be connected to the line of the refrigeration unit between the compressor and the condenser, the heating loop connected to the line at an upstream location and at a downstream location;
a heating valve connected to the heating loop;
a thermostatic control connected to the heating valve and configured to open the heating valve to allow refrigerant to enter the heating loop at the upstream location and exit the heating loop at the downstream location; and
a reservoir heat exchanger connected to the heating loop and configured to allow refrigerant to enter the reservoir heat exchanger to transfer heat to a food product reservoir.

2. The heating system of claim 1, wherein the heating valve is located proximate the upstream location.

3. The heating system of claim 1, wherein the heating valve is located proximate the downstream location.

4. The heating system of claim 1, wherein the heating valve is a solenoid valve.

5. The heating system of claim 1, further comprising a means for restricting the flow of refrigerant within the line connecting the compressor to the condenser.

6. A food dispenser refrigeration system, comprising:
a refrigeration unit having
a compressor to compress a refrigerant from a low pressure to a high pressure;
a condenser for cooling said refrigerant;
a bypass loop for allowing refrigerant to pass between the compressor and the condenser;
an expansion device for expanding a portion of said refrigerant to a lower pressure; and
an evaporator for exchanging heat with a freezing cylinder or hopper containing food product;
a heating loop connected to the bypass loop at an upstream location and at a downstream location;
a heating valve connected to the heating loop;
a thermostatic control connected to the heating valve and configured to open the heating valve to allow refrigerant to enter the heating loop; and
a reservoir heat exchanger connected to the heating loop and configured to allow refrigerant to enter the reservoir heat exchanger to transfer heat to a food product reservoir.

7. The heating system of claim 6, further comprising a bypass valve connected to the bypass loop.

8. The heating system of claim 7, wherein the thermostatic control is connected to the bypass valve and configured to close the bypass valve to prevent refrigerant from entering the bypass loop.

9. The heating system of claim 6, further comprising a restriction element connected to the bypass loop to create a pressure drop along the bypass line.

10. The heating system of claim 6, wherein the heating valve is a solenoid valve.

11. The heating system of claim 7, wherein the bypass valve is a solenoid valve.

12. A method for heating a food product, comprising:
compressing a refrigerant from a low pressure to a high pressure;
directing the high pressure refrigerant to a heating loop for transferring heat to a food product reservoir;
directing the refrigerant from the heating loop to a condenser for cooling the refrigerant;
expanding the refrigerant to a lower pressure;
directing the low pressure refrigerant to an evaporator to accept heat from and cool a freezing cylinder; and
directing the lower pressure refrigerant to a compressor.

13. The method of claim 12, further comprising directing high pressure refrigerant along a bypass loop to a condenser for cooling the refrigerant.

14. The method of claim 12, further comprising monitoring a temperature of the food product reservoir and outputting a signal based on the temperature of the food product reservoir.

15. The method of claim 14, further comprising switching the flow of high pressure refrigerant between the heating loop and the bypass loop in response to the signal based on the temperature of the food product reservoir.

16. The method of claim 13, further comprising restricting the flow of high pressure refrigerant along the bypass loop.

17. The method of claim 12 wherein:
the step of directing the high pressure refrigerant to a heating loop for transferring heat to a food product comprises directing all of the high pressure refrigerant to the heating loop; and
the step of directing the refrigerant from the heating loop to a condenser for cooling the refrigerant comprises directing all of the refrigerant from the heating loop to the condenser.

18. A system for using waste heat of a refrigeration unit to heat a food product, the refrigeration unit having a refrigerant line connecting a compressor to a condenser for passing pressure high refrigerant from the compressor to the condenser, the heating system comprising: a heating loop interdisposed in the refrigerant line in heat exchange relationship with a reservoir for storing the food product whereby all the high pressure refrigerant passing from the compressor to the condenser traverses the heating loop.
